(19) United States
(12) Patent Application Publication
(10) Pub. No.: US 2008/0127179 A1
(43) Pub. Date: May 29, 2008

(54) System and apparatus for deployment of application and content to different platforms

(76) Inventors: Barrie Jon Moss, Cumbria, CA (US); Dean Brown, Ann Arbor, MI (US)

Correspondence Address: REED SMITH, LLP, TWO EMBARCADERO CENTER, SUITE 2000, SAN FRANCISCO, CA, 94111, US

(21) Appl. No.: 11/527,256

(22) Filed: Sep. 25, 2006

(51) Int. Cl. G06F 9/445

(52) U.S. Cl. 717/175; 717/174

(57) ABSTRACT

Content and applications are selected from a warehouse and prepared in a distributable release targeting the device on which the content and/or application are to be viewed/run. The content and applications are, for example, device independent programs or graphics. The programs and graphics are selected generally by a user of the device, and a specific version of the application, or resolution of the content are selected from a warehouse of applications and content, the selections being made to specifically target the capabilities of the device. The distributable may include engines or device specific programs, interfaces, etc needed to make the application(s) run on the target device. Micro-provisioning is utilized to prevent duplication of any components already installed or present on the target device.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to the preparation and distribution of content and applications to platforms.

2. Discussion of Background

Currently, applications are created by a developer and compiled using a compiler tied to the language used to create the program and the Operating System which it is compiled on. An application may include generated or internally stored graphics, or additional files containing graphics, audio or other content that may be associated with and used by it or other the applications. The resulting product is delivered to the user's machine though an installation method.

The state of electronic equipment today spans a broad range of devices often including different versions of the same device, each having different display, and user interface capabilities and procedures, different operating systems, and a wide range of add-on peripheral or integral components. Many of the devices are portable with limited bandwidth and storage capacity of varying amounts. Even with devices that utilize the same operating system and processor will have different screen resolutions, keyboard or lack of keyboard, and different control sets to control applications on these devices.

### SUMMARY OF THE INVENTION

The present inventors have realized the need to customize and deploy applications and content for a wide variety of devices. Roughly described, the present invention is a system for targeting a device with only the content needed in order to operate efficiently on the device. That targeting includes, for example, how to operate on the targeted device (and/or platform) (e.g., control sets, keyboard, trackball, mouse, touch screen, etc as needed), and keeping the actual distributable going out to these platforms as small as possible, especially when the device itself may have limited resources for storage or when delivering over the air or other limited/cost sensitive bandwidth content delivery mechanisms. In other words, the present invention avoids sending content, such as imagery, that's targeted at a set top box or a PC screen (e.g., HDTV resolutions) to a device such as a low resolution cell phone screen whose limited capability may be, for example, a quarter VGA or a 240 by 320 display.

In one embodiment, the present invention provides a system for deployment, comprising, a mechanism configured to retrieve specifications of an electronic device, a deployment device configured to prepare a target package adapted to the specifications of the electronic device, and a distribution mechanism configured to communicate the target package to the electronic device.

In various alternatives, the system may include features such as where the target package comprises an application and data for the application, the application is configured to execute using the operating system, and the data comprises data selected from a pool of data best matching parameters of the electronic device. In one embodiment, the data is an image file having a native resolution closely matching resolution capabilities of a display screen on the electronic device.

In one embodiment, the deployment device builds the deployment package on-the-fly after receipt of a request for the package, and in another embodiment, the deployment device selects the deployment package from a set of deployment packages prepared prior to receipt of a request for the deployment package.

The present invention includes a database of products comprising applications and content for distribution in the target package. The database content comprises, for example, at least one series of content comprising a same subject at different resolutions (e.g., image, movie or office product files at different resolutions), and/or the same or similar applications using different control sets for retrieving inputs or other data used to run the applications. The different resolutions may include, for example, at least one resolution adapted for small screen devices and at least one resolution for larger screens.

The content may also include operating systems and applications that themselves may include graphics or images at varying resolutions in addition to any other features, such as control sets, that may also differ between the same or similar operating systems and/or applications. The operating systems may include, for example, versions of a platform independent operating system, each version adapted for a specific plat form, including any of Windows based platforms, Linux based platforms, and PDA/phone based platforms. In one embodiment, the database includes at least one version of an Amiga Anywhere™ operating system or another operating system of the same type as Amiga Anywhere™.

The electronic devices may be any one or more of a memory card, cell phone, PDA, computing device, or other electronics or virtual devices. In various embodiments, at least one component of the system may be embodied in a set of computer instructions stored on a computer readable media as, for example, compiled computer instructions stored as an executable program on the computer readable media.

The invention may take any modern form, including a web page providing a user interface, or a kiosk with a user interface including a selection mechanism configured to allow the user to select at least one of applications and content for including in the packaged file and the packaged file is delivered to the user via at least one of writing to memory disk inserted by the user into the kiosk, wireless communications with the device, and Internet based communication to at least one of the user and the device.

In one embodiment, the invention is a method, comprising the steps of, receiving specifications of a device, selecting an application and content based on the specifications, packaging the application and content in a file, and delivering the file. The steps may also include selecting an operating system or other applications and content, and including the operating system and other applications and content in the packaged file.

Portions of both the system, device, and method may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a deployment system according to an embodiment of the present invention;

FIG. 2 is a drawing of a deployer kiosk located at a sports arena according to an embodiment of the present invention;

FIG. 3 is a block diagram of a deployment system according to an embodiment of the present invention;

FIG. 4 is a flow chart of a content process flow according to an embodiment of the present invention;

FIG. 5 is a flow chart of a platform support flow according to an embodiment of the present invention; and

FIG. 6 is a flow chart of a deployer process according to an embodiment of the present invention.

### DESCRIPTION OF THE PREFERRED EMBODIMENTS

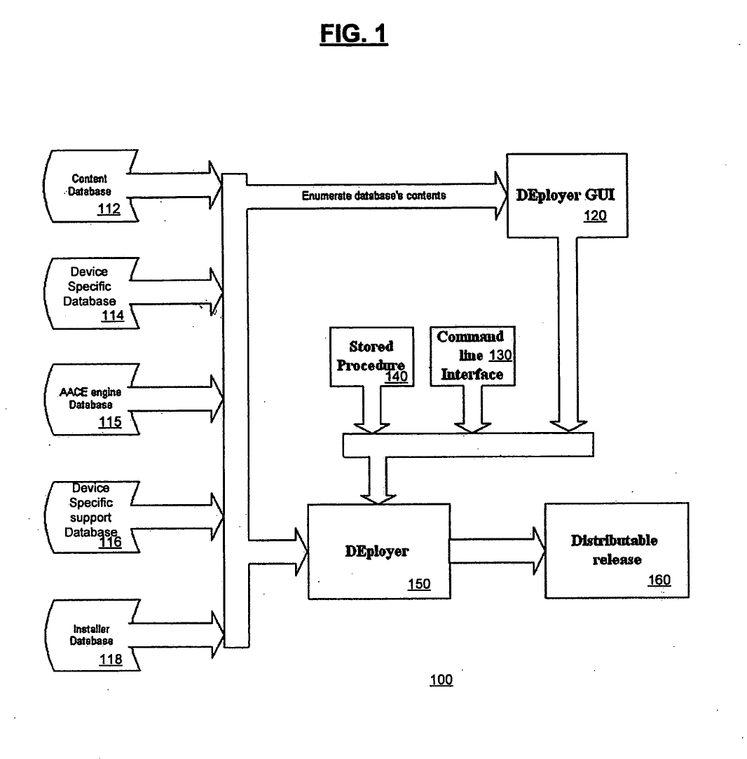

Referring now to the drawings, wherein like reference numerals designate identical or corresponding parts, and more particularly to FIG. 1 thereof, there is illustrated FIG. 1 is a block diagram of a deployment system 100 according to an embodiment of the present invention. The deployment system includes, for example, a warehouse 110, a deployer GUI 120, a command line interface 130, stored procedure(s) 140, a deployer 150, and illustrates a distributable release 160.

The warehouse 110 is, for example, a web server or some type of database and a machine in communication with at least one other component of the invention (e.g., a database networked to the deployer 150 and/or deployer GUI 120). The warehouse and databases contain the pieces necessary for putting together a deliverable, such as the distributable release 160. The warehouse includes, for example a content database 112, a device specific database 114, an operating system (AACE O/S in this example) 115, a device specific support database 116, and an installer database 118. A different set of databases and/or additional databases may be utilized depending upon the applications, devices, or contents targeted by the deployment system.

The Deployer GUI 120 provides an interface for a user, who wishes to select an application, content or other item for a device. For, example, the GUI may be implemented on a kiosk and the GUI retrieves specification of the device from the user (e.g., via responding to queries, filling out check boxes, or making selections from the GUI), or the device itself (e.g., kiosk to device communications through Bluetooth or other wireless method). The GUI may also be configured to query the user to determine what content is to be distributed to the user, and collect payment if applicable. The distributable content might also be part of a subscription program that is wirelessly verified and automatically uploaded to the device. In sum, the GUI is one mechanism by which the deployment system determines what the user's device is, and what content is requested/to be distributed.

In one embodiment, the distributable content is written directly to a memory card inserted into the kiosk. In other embodiments, the distributable content is wirelessly communicated to the user's device (e.g., Bluetooth communication, cellular network communication, or Internet based communication (including an email to the device or user of the device).

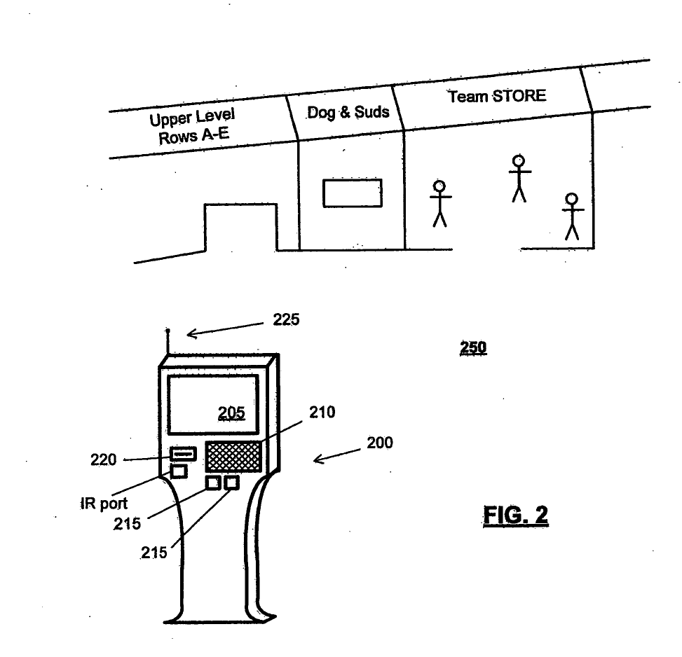

FIG. 2 is a drawing of a deployer kiosk 200 according to an embodiment of the present invention. The deployer kiosk 200 includes a touch screen 205, pointing device/keyboard 210, memory card slots 215, Bill acceptor/credit card device 220, and wireless capability 225. The kiosk also includes processing and bus communications between the illustrated devices (not shown). The processing capability includes, for example, a deployer system such as that described in FIG. 1. The kiosk 200 is shown in a sports arena, but could also be located in any other venue. The kiosk 200 is, for example, an outlet where users may purchase content that's actually targeted at the teams or the sports being played at the sports arena. The content is, for example, content, applications, etc., that are targeted to a user's cell phone (e.g., games that can be played while waiting for the game, concert, or other venue attraction to start). The games may be, for example multi-user games for competition amongst like sports-fans.

Other content may include, for example, the capability to take photographs and build an application up with a set of photographs, or, provide playback the highlights of the game (or other events). The kiosk may also include functions for the sale of any other type of items, including ordering food, purchase of physical memorabilia, etc, that are normally available through brick and mortar vendors at the sports arena 250 or other venue.

The command line interface 130 is a different type of interface, intended for different types of users. The GUI is mainly targeted towards end users, the command line interface is targeted more toward e-tailer or someone building an on-line store that would carry one or more items of the content/applications to be deployed. Facilities might include, for example, listings and promotional materials describing the content/applications. An e-tailer or on-line store proprietor would take the information for sales in from their own interface and send it off to the command line interface to get the distributable release for a particular customer.

The materials available may include certain SKUs that are pre-built for particular platforms and applications and already available to be included in a distributable release, and/or a stored procedure (e.g., stored procedure(s) 140) that would be used to generate content either off-line or on the fly to satisfy an immediate request.

Thus, the stored procedures 140, are, for example, used internally by the system to prepare data (e.g., building up to go in a store as fixed content sets(s)), or perform repeated tasks, system housekeeping, etc. For example, the system, and particularly the deployer 150 may build up distributable releases with three or four pieces of content in one deliverable. That distributable/deliverable appears as a single file delivered to the end user. But in fact the deliverable actually can contain multiple different packages, different pieces of content, etc.

Distributable releases may include, for example, playoffs, division championships, and games or other applications built around those events (e.g., fantasy leagues, puzzles, quizzes, etc.). Puzzles might include, a picture puzzle where the user receives a scrambled picture and attempts to put it back together, the puzzle(s) being one or more images from the playoffs, championships, etc. In one mode of operation, deployer prepares an application with several different sets. In another mode, deployer prepares multiple different applications that can be put together as a batch for covering an entire sport or other event.

Such targeted applications may be included on a memory card sold at retail outlets, over the Internet, or by subscription. The targeted applications might be puzzle packs or other gaming packs. Each pack may include multiple applications and content sets. A stored procedure is used to automate build up for those content/application sets to build an image that would go onto the card. The delivery is not necessarily electronic, but could be a physical delivery of the card.

The distributable packages are targeted to a specific device, or specific class of devices (e.g., PDAs, or PDAs meeting specific ranges of specification—e.g., PDA w/more than 32 MB storage and VGA screen, HDTV content, wireless device content, etc.) The deployer 150 makes decisions based upon availability of content and applications, availability to be sent out, and the device (including user customizable capabilities) the applications/content is sent to. There may be, for example, a 2-way communication with the device such that the device notifies the system about certain pieces of content or applications that are already resident on the device. Since those pieces already exist, deployer keeps them out of the content being sent in the distributable for that device. Thus, deployer customizes the distributable to cut out any duplication, only sending the minimal pieces needed (micro delivery of content).

Another example is the playing of a game having multiple levels. At first, only the first few levels are needed. Only after the user progresses to higher levels is there any need for additional levels. As the user plays and progresses, the user decides s/he needs more, and deployer can then package and sell additional levels to the user. If on subscription, the levels can be uploaded during a next synch with a kiosk, Bluetooth portal, or other communication mechanism or receive the additional levels through the device's own communication capabilities. Deployer functions to keep the whole game from being uploaded onto a potentially limited capacity device, keeps the game or portions thereof from being loaded over and over by only preparing distributables with parts of the game that are needed.

In essence, in various embodiments, the distributable release is a package that gets sent to the user's device containing necessary components for the requested content. The distributable releases may include a static deployment package that would be used for an internal store that is, for example, targeting a class of devices rather than a specific device. This may include imagery that will support both a SmartPhone device and a PDA, devices that are small form factor. The static deployment package would be prepared, for example, for a retail game card. The static package, while specifically prepared to target a certain class of devices, covers the widest variety of devices in that class, and does so in a way that limits the number of SKUs in physical inventory.

Alternatively, a dynamic package would be prepared for a specific device itself and only give the content pieces that are necessary for that specific device. Within a specific device, different versions and different amounts of optional items, like storage, screen size, etc are taken into account to build the appropriate, smallest package that takes advantage of the version, specifications, and other capabilities of the device.

In each case, micro-provisioning, where a user's device may already have certain pieces of the content that they need, but they do not have all of it (like additional levels of a game, recent updates, etc.), may be applied. Micro-provisioning applies to both static and dynamic packages. For example, a game card that has a game on it and half a dozen levels and a user then may micro-provision additional levels in on top of the existing levels. Although originally provided in a static package deployment (e.g., the main portion of content), does not exclude the system from micro-provisioning additional items or content.

The distributable releases are, for example, is delivered in any available method. For example, the present invention includes distributable delivery via a p-code or a pseudo-code, that is compiled when loaded into the device (compiled into the native machine language format). In this way, the content will naturally run across multiple different processors.

As noted in FIG. 1, the AACE engine database is a specific example. The AACE is the Amiga Anywhere™ Content Engine. The AACE includes a machine specific part and a machine non-specific part. And is one example of a platform independent operating system. Being a specific example, many other types of operating systems may be provided from other databases. Again, deployer would make the decision as to the operating system, whether AACE targeted for a specific machine, or another operating system, and include it in the single distributable release as appropriate/needed.

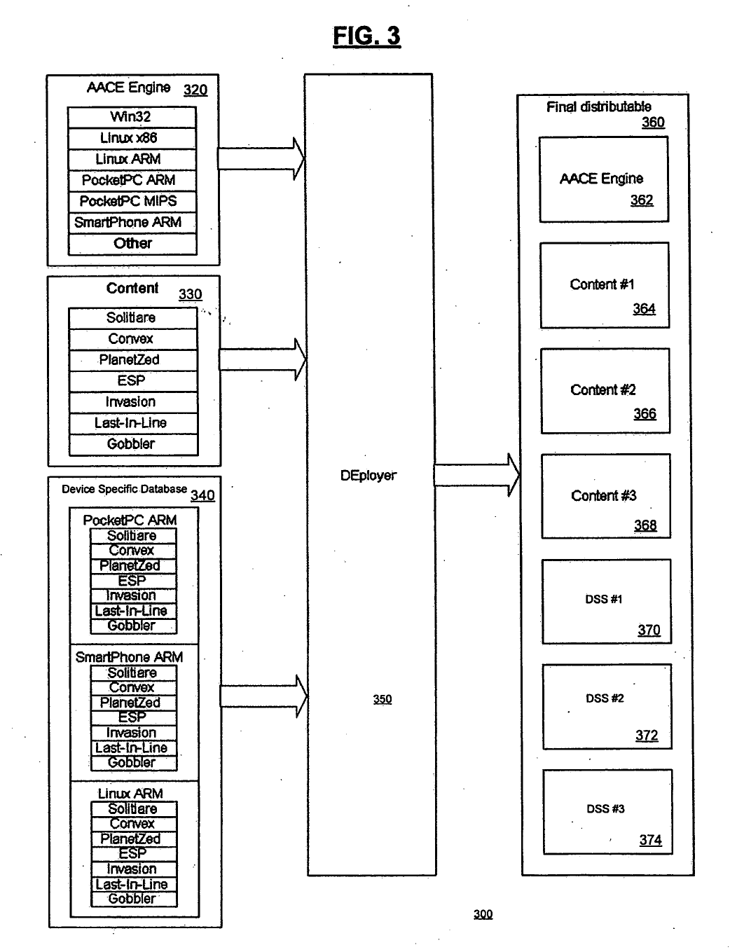

FIG. 3 is a block diagram of a deployment system according to an embodiment of the present invention. FIG. 3 provides a more specific idea of engines that run on different platforms, for example, any number of engines that run on one or more of Win32, Linux, PocketPC, etc. An Amiga Anywhere™ Content Engine (AACE) 320 provides a specific example, the content engine having versions for each of Win32, Linux x86, Linux ARM, PocketPC ARM, PocketPC MIPS, and SmartPhone ARM. FIG. 3 also illustrates examples of content 330 non-specific to the platform, and device specific items (Device Specific Database 340) which include, for example, device specific modules needed to run certain applications on specific platforms.

All of the above described pieces may go into creating a distributable. The pieces are in the warehouse, or more specifically in databases of the warehouse. Deployer 350 selects specific versions of engines or other applications and corresponding content (or any combination of items in the warehouse) and puts them together in the distributable. The distributable may, for example, take the form of a game pack (e.g. pocket-pc format) in any other form distributable to any platform. In FIG. 3, distributable 360 is illustrated and includes a version of the AACE Content Engine 362, content selections 1-3 (364-368), and device specific selections DSS 1-3 (370-374).

The platforms may include, for example, other Win-CE based devices, cell phones, or mixed platform devices (e.g.) pc's that operate as cell phones, (e.g. Windows Mobile Five type devices), etc. As described, the distributable may have selections from each of the databases in the warehouse. However, the distribution does not have to have selections from each of the databases.

A single card may have a distribution (distributable) with an engine, content, and then a way of launching each one of those pieces of content. In contrast, the deliverable may only include a game and content without the engine (e.g., without an AACE or other engine), generally depending, for example, upon whether an acceptable/compatible engine is already available on the device.

The AACE engine is widely utilized and runs on PocketPC, SmartPhones, and is specific to the device that it is running on. AACE includes the device specific portion of the distributable.

The content itself is intended to be non-device specific. For example, solitaire, uses the same code, the same deliverable will work on a Linux-based machine or a Windows-based machine, or a SmartPhone. There may be different versions selected by deployer based memory requirements or other specifications of a target device. Or, for example, the graphics for the particular resolution supported on the specific device. So, the solitaire program may remain the same, but different graphics packages suitable for memory requirement and capabilities of the target device are utilized.

The content is further subdivided as required to get to a level of detail appropriate for the content. Beyond a single game, game packs for different games or versions of the same game are customized. In some cases, games cannot play on a particular device because not enough real estate is available on the screen or other requirements (e.g. memory, control requirements, etc.) Game pack customization eliminates additional bandwidth needed to communicate the pack and eliminates customer dissatisfaction when a particular game version is not compatible with the customer's device or platform.

Should the device or platform have sufficient space, such as a desktop machine or a Linux-based machine that has a higher resolution screen, the complete game pack or game pack targeting higher resolutions is selected. For example, certain games of solitaire that use two decks of cards, that there may be insufficient room on the screen of a SmartPhone or other small device to play that game because not enough pixels are available to put all the cards down).

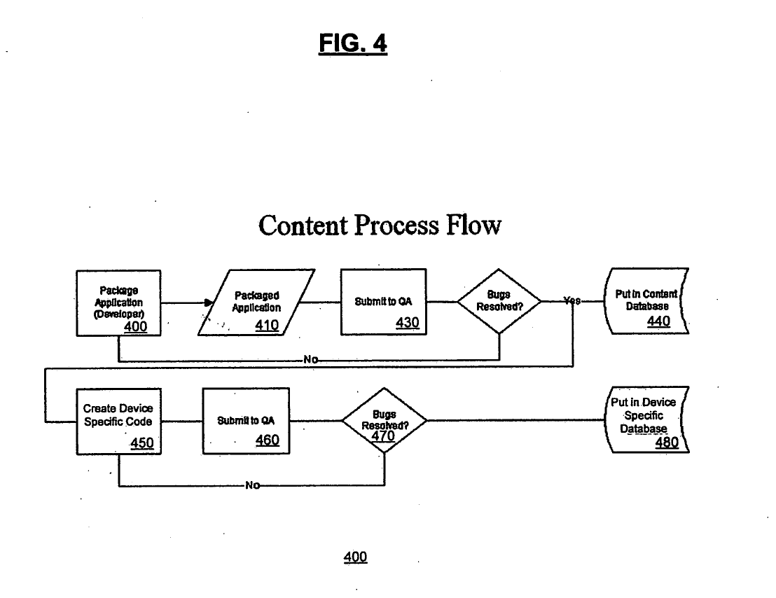

FIG. 4 is a flow chart of a content process flow 400 according to an embodiment of the present invention. Process describes how an application developer creates application content to put into the warehouse, or database in the warehouse. A package is prepared by a developer (step 410). The application or content is packaged (step 420), and submitted to Quality Assurance (QA) (step 430). Upon approval, the package is entered into an appropriate database in the warehouse (step 440). If the package is not approved, then a device specific application is developed and then refined until approved (450-470) and then entered into the appropriate database of the warehouse (e.g., Device Specific Database of the warehouse)(step 480).

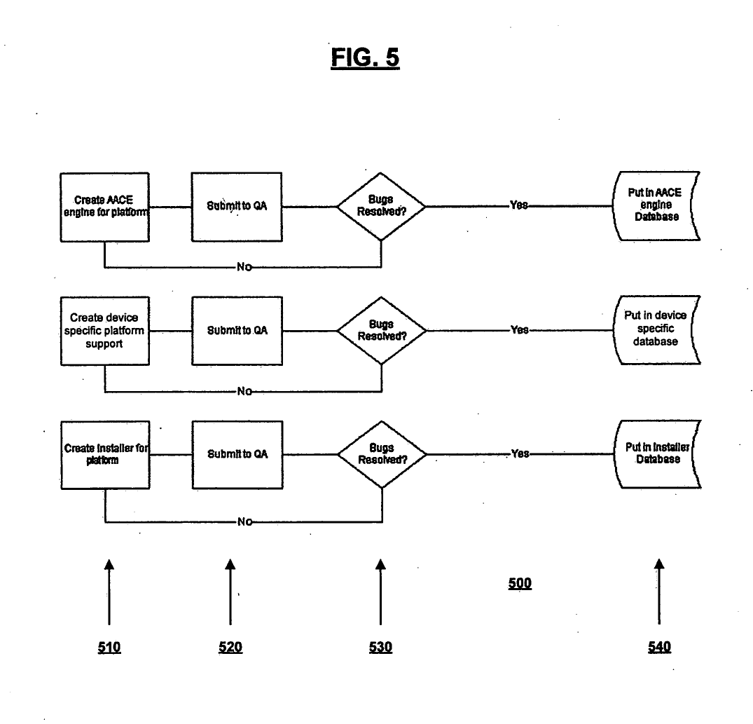

FIG. 5 is a flow chart of a platform support flow 500 according to an embodiment of the present invention. The platform support flow 500 is a process for preparing one of a content engine, device specific items, or Installer applications for inclusion in the database. At step 510, the appropriate platform support application is developed. QA reviews and tests the application as required (step 520). Bug fixes or necessary design changes are sent back to the developer (step 530), and, on approval, the application is entered into the appropriate database of the warehouse (step 540).

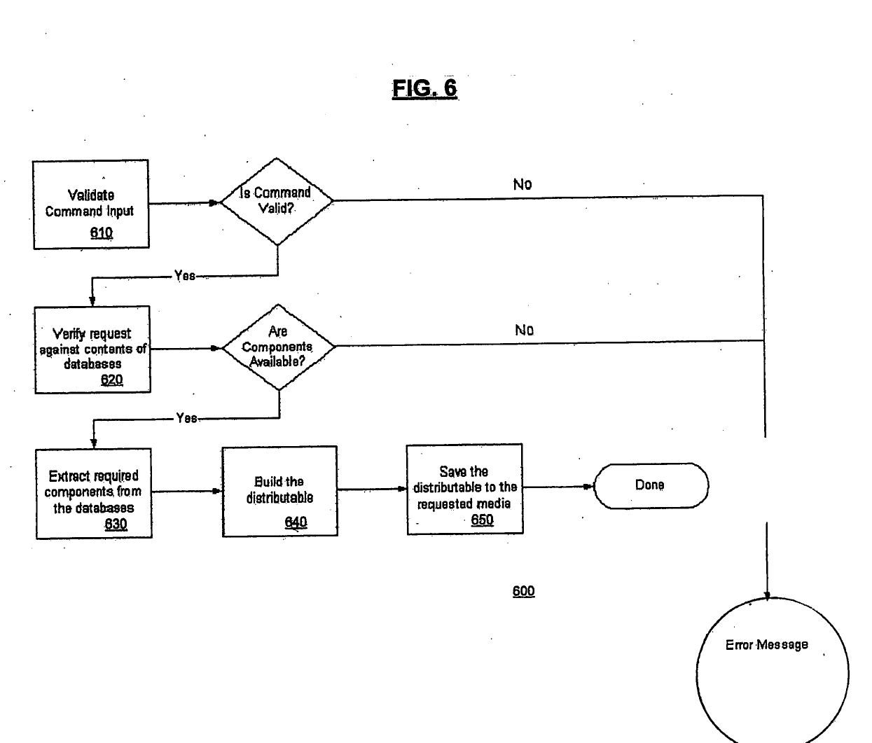

FIG. 6 is a flow chart of a deployer process 600 according to an embodiment of the present invention. The deployer process flow is a process that makes content available to the consumer or end user. At step 410, a user input is validated. The user input is, for example, a request entered on a GUI (e.g., GUI 120), or a command line interface entry (e.g., from command line interface 130). The validated input is, for example, a request for content, application(s), or other components. The validated input is then verified against the content of the database, assuring the request can be filled (step 620). The requested components are then extracted from the database (step 630), and deployer builds the distributable (step 640). The distributable includes the requested component, any other requested components, and any other necessary applications, engines, or other components needed for proper operation of the requested component(s). At step 650, the distributable is saved to a requested media (e.g., memory card) or transmitted to the requesting user (email, cell phone download, etc.).

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing game pack, platform, or communication mechanism, any other equivalent device, or other devices having an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to user interfaces, processes, systems, media, formats, operating systems, resolutions, control systems etc. should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW+/−, micro-drive, and magneto-optical disks, ROMs, RAMS, EPROMS, EEPROMS, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, identification selection and retrieval of programs, graphics, operating systems, and the, copying of packaging, unloading and/or transport (e.g., trailers) of piece and/or distributed release including the transmission thereof in electronic signals in any format, frequency, or protocol, and the display, storage, or communication of results according to the processes of the present invention.

The present invention may suitably comprise, consist of, or consist essentially of, any of element (the various parts or features of the invention, and their equivalents as described herein or otherwise available. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A system for deployment, comprising:
a mechanism configured to retrieve specifications of an electronic device;
a deployment device configured to prepare a target package adapted to the specifications of the electronic device; and
a distribution mechanism configured to communicate the target package to the electronic device.

2. The system according to claim 1, wherein the target package comprises an application and data for the application.

3. The system according to claim 2, wherein the target package further comprises an operating system specifically adapted to run on the electronic device.

4. The system according to claim 2, wherein:
the target package further comprises an operating system configured to run on the electronic device;
the application is configured to execute using the operating system; and
the data comprises data selected from a pool of data best matching parameters of the electronic device.
wherein the data is an image file having a native resolution closely matching resolution capabilities of a display screen on the electronic device.

5. The system according to claim 1, wherein the deployment device builds the deployment package on-the-fly after receipt of a request for the package.

6. The system according to claim 1, wherein the deployment device selects the deployment package from a set of deployment packages prepared prior to receipt of a request for the deployment package for the electronic device.

7. The system according to claim 1, further comprising a database of products comprising applications and content for distribution in the target package.

8. The system according to claim 7, wherein the database content comprises at least one series of content comprising a same subject at different resolutions.

9. The system according to claim 7, wherein the database content comprises at least one series of image files of the same subject at varying levels of image resolution.

10. The system according to claim 7, wherein the database content comprises at least one series of image files of the same subject at varying levels of image resolution, including at least one resolution adapted for small screen devices and at least one resolution for larger screens.

11. The system according to claim 10, wherein the database content comprises operating systems, content, and applications.

12. The system according to claim 11, wherein the operating systems comprise versions of a platform independent operating system, each version adapted for a specific plat form, including any of Windows based platforms, Linux based platforms, and PDA/phone based platforms.

13. The system according to claim 11, wherein the operating systems comprise different versions of an Amiga Anywhere Style Operating system.

14. The system according to claim 7, wherein the specifications include a screen resolution of the electronic device and the deployment device is further configured to match resolution of a file in the database to the screen resolution and include the matched resolution file in the target package.

15. The system according to claim 1, wherein the electronic device comprises one of a memory card, cell phone, PDA, computing device.

16. The system according to claim 1, wherein:
at least one component of the system is embodied in a set of computer instructions stored on a computer readable media;
said computer instructions, when loaded into a processing device, cause the processing device to perform at least one of a function and a process of the system.

17. The method according to claim 16, wherein said computer instructions are compiled computer instructions stored as an executable program on the computer readable media.

18. The system according to claim 1, wherein at least part of the system is embodied in a set of computer readable instructions stored in an electronic signal.

19. The system according to claim 1, wherein the system is administered for the benefit of a consumer by a kiosk.

20. The system according to claim 16, wherein the kiosk comprises a user interface including a selection mechanism configured to allow the user to select at least one of applications and content for including in the packaged file.

21. The system according to claim 20, wherein the packaged file is delivered to the user via at least one of writing to memory disk inserted by the user into the kiosk, wireless communications with the device, and Internet based communication to at least one of the user and the device.

22. A computer readable media and a set of instructions stored by the computer readable media that, when loaded into a computer, cause the computer to perform the steps of:
receiving specifications of a device;
selecting an application and content based on the specifications;
packaging the application and content in a file; and
delivering the file.

23. The computer readable media according to claim 22, wherein the content comprises at least one graphic selected to closely match a resolution specification of the device.

24. The computer readable media according to claim 22, wherein the steps further comprise selecting an operating system adapted for the device and including the operating system in the packaged file.

25. A deployment package, comprising:
a device specific engine; and
at least one application selected from a pool of available applications, the selected application having at least one performance parameter matching a performance parameter of a target device.

26. The deployment package according to claim 25, wherein the performance parameter comprises at least one of memory capacity, screen resolution, and processor speed of the target device.

27. The deployment package according to claim 25, wherein the at least one parameter matching a performance parameter comprises being closer matched to the performance parameter of the target device compared to other similar applications in the pool of available applications.

28. The deployment package according to claim 25, wherein the at least one application comprises a suite of applications having similar performance parameters.
